(19) United States
(12) Patent Application Publication
(10) Pub. No.: US 2026/0262083 A1
(43) Pub. Date: Sep. 3, 2026

(54) TECHNIQUES FOR REPEATING CHANNEL OCCUPANCY TIME SHARING INFORMATION

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Changlong XU, Beijing (CN); Shaozhen GUO, Beijing (CN); Luanxia YANG, Beijing (CN); Hao XU, Beijing (CN)

(21) Appl. No.: 19/159,957

(22) PCT Filed: May 5, 2023
(86) PCT No.: PCT/CN2023/092169

§ 371 Date: Aug. 26, 2025

(51) Int. Cl. H04W 74/0808; H04W 74/00; H04W 88/04

(52) U.S. Cl. CPC H04W 74/0808; H04W 74/002; H04W 88/04

(57) ABSTRACT

Various aspects of the present disclosure generally relate to wireless communication. In some aspects, a first user equipment (UE) may receive, from a second UE via a sidelink, channel occupancy time (COT) sharing information (COT-SI) associated with a first portion of a COT. The UE may identify, based at least in part on the COT-SI, that the first UE is an eligible repeater UE of the COT-SI. The UE may transmit, based at least in part on the first UE being the eligible repeater UE of the COT-SI, a communication using the first portion of the COT, the communication including a repeated COT-SI. Numerous other aspects are described.

### FIELD OF THE DISCLOSURE

Aspects of the present disclosure generally relate to wireless communication and to techniques and apparatuses for repeating channel occupancy time sharing information.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a first user equipment (UE). The method may include receiving, from a second UE via a sidelink, channel occupancy time (COT) sharing information (COT-SI) associated with a first portion of a COT. The method may include identifying, based at least in part on the COT-SI, that the first UE is an eligible repeater UE of the COT-SI. The method may include transmitting, by the first UE and based at least in part on the first UE being the eligible repeater UE of the COT-SI, a communication using the first portion of the COT, the communication including a repeated COT-SI.

Some aspects described herein relate to a method of wireless communication performed by a first UE. The method may include transmitting, to a second UE via a sidelink, COT-SI associated with a first portion of a COT. The method may include indicating whether the second UE is an eligible repeater UE of the COT-SI.

Some aspects described herein relate to a first UE for wireless communication. The first UE may include a memory and one or more processors coupled to the memory. The one or more processors may be configured to receive, from a second UE via a sidelink, COT-SI associated with a first portion of a COT. The one or more processors may be configured to identify, based at least in part on the COT-SI, that the first UE is an eligible repeater UE of the COT-SI. The one or more processors may be configured to transmit, based at least in part on the first UE being the eligible repeater UE of the COT-SI, a communication using the first portion of the COT, the communication including a repeated COT-SI.

Some aspects described herein relate to a first UE for wireless communication. The first UE may include a memory and one or more processors coupled to the memory. The one or more processors may be configured to transmit, to a second UE via a sidelink, COT-SI associated with a first portion of a COT. The one or more processors may be configured to indicate whether the second UE is an eligible repeater UE of the COT-SI.

Some aspects described herein relate to a non-transitory computer-readable medium that stores a set of instructions for wireless communication by a first UE. The set of instructions, when executed by one or more processors of the first UE, may cause the first UE to receive, from a second UE via a sidelink, COT-SI associated with a first portion of a COT. The set of instructions, when executed by one or more processors of the first UE, may cause the first UE to identify, based at least in part on the COT-SI, that the first UE is an eligible repeater UE of the COT-SI. The set of instructions, when executed by one or more processors of the first UE, may cause the UE to transmit, based at least in part on the first UE being the eligible repeater UE of the COT-SI, a communication using the first portion of the COT, the communication including a repeated COT-SI.

Some aspects described herein relate to a non-transitory computer-readable medium that stores a set of instructions for wireless communication by a first UE. The set of instructions, when executed by one or more processors of the first UE, may cause the first UE to transmit, to a second UE via a sidelink, COT-SI associated with a first portion of a COT. The set of instructions, when executed by one or more processors of the first UE, may cause the first UE to indicate whether the second UE is an eligible repeater UE of the COT-SI.

Some aspects described herein relate to an apparatus for wireless communication. The apparatus may include means for receiving, from a UE via a sidelink, COT-SI associated with a first portion of a COT. The apparatus may include means for identifying, based at least in part on the COT-SI, that the apparatus is an eligible repeater of the COT-SI. The apparatus may include means for transmitting, based at least in part on the apparatus being the eligible repeater of the COT-SI, a communication using the first portion of the COT, the communication including a repeated COT-SI.

Some aspects described herein relate to an apparatus for wireless communication. The apparatus may include means for transmitting, to a UE via a sidelink, COT-SI associated with a first portion of a COT. The apparatus may include means for indicating whether the UE is an eligible repeater UE of the COT-SI.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications and access link communications, in accordance with the present disclosure.

FIGS. 5A-5B are diagrams illustrating an example of sidelink communications, in accordance with the present disclosure.

FIG. 6 is a diagram of an example associated with repeating channel occupancy time sharing information, in accordance with the present disclosure.

FIG. 7 is a diagram illustrating an example process performed, for example, by a first UE, in accordance with the present disclosure.

FIG. 8 is a diagram illustrating an example process performed, for example, by a first UE, in accordance with the present disclosure.

FIG. 9 is a diagram of an example apparatus for wireless communication, in accordance with the present disclosure.

### DETAILED DESCRIPTION

In some wireless communication systems, one or more network entities may communicate using an unlicensed spectrum. For example, two or more user equipments (UEs) communicating via a sidelink may communicate in an unlicensed frequency band, sometimes referred to as sidelink-unlicensed (SL-U). In such cases, a first UE (sometimes referred to as an initiating UE, an initiator UE, and/or a channel occupancy time (COT) initiator UE) may perform a listen-before-talk (LBT) procedure or a similar procedure to contend for access to an unlicensed channel. The LBT procedure may result in the initiating UE gaining access to the unlicensed channel for a duration referred to as a COT, during which the initiating UE may perform transmissions without performing additional LBT operations. In some cases, the initiating UE may share the COT with other UEs (sometimes referred to as responding UEs, responder UEs, or COT responder UEs). To enable responding UEs to utilize a portion of the COT (sometimes referred to as a sharable region of the COT), the initiating UE may transmit certain information (e.g., using sidelink control information (SCI)) about the COT, which is sometimes referred to as COT sharing information (COT-SI). The COT-SI may include information such as an indication of a channel access priority class (CAPC) associated with the COT, a remaining COT duration in the sharable region of the COT, a layer 1 (L1) identifier (ID) associated with the COT (e.g., an LI destination ID, an L1 source ID, and/or a similar L1 ID), an indication of one or more resource block (RB) sets associated with the COT, additional IDs associated with the COT (e.g., a COT sharing ID), and/or other information associated with the COT. Based at least in part on the information indicated by the COT-SI, a responding UE may utilize resources within the sharable region of the COT for sidelink transmissions.

In some cases, one or more responding UEs may not successfully receive the COT-SI. For example, an initiating UE may transmit SCI containing COT-SI in a first slot of the COT, which may be missed by half-duplex UEs that are otherwise communicating (e.g., transmitting) during that time. This may result in unutilized resources, increased congestion among sidelink UEs, and/or otherwise inefficient usage of network resources because some responding UEs may perform otherwise unnecessary LBT procedures and/or reserve additional resources for sidelink communication rather than utilizing available resources in the sharable region of the COT. In such cases, it may be desirable to permit responding UEs to carry COT-SI within their own transmitted SCI (sometimes referred to as COT-SI repetition and/or COT-SI forwarding), such as for purposes of redundantly sharing COT-SI multiple times during the COT to ensure all eligible UEs receive the COT-SI. However, COT-SI forwarding performed by multiple responding UEs may result in high signaling overhead and/or congested channels. Moreover, a responding UE receiving forwarded COT-SI may be unable to identify whether the UE may use the COT to respond to the initiator UE or the repeating UE, resulting in communication errors and thus high power, computing, and network resource consumption associated with correcting communication errors.

Some techniques and apparatuses described herein enable efficient COT-SI forwarding in UE-to-UE COT sharing applications. In some aspects, a responding UE may receive a COT-SI associated with a sharable region of a COT. The responding UE may identify whether it is an eligible repeater UE of the COT-SI, which may be based at least in part on whether the responding UE is a data receiver of the initiating UE, whether the responding UE is a target UE of COT sharing, whether the responding UE is within a given range of the initiating UE, whether the responding UE is capable of decoding the COT-SI, or whether the responding UE meets other criteria. In aspects in which the responding UE is an eligible repeater UE of the COT-SI, the responding UE may repeat and/or forward the COT-SI when transmitting a communication in the sharable region of the COT, thereby repeating the COT-SI for certain UEs that may have otherwise missed the COT-SI from the initiating UE due to half-duplex operation or for other reasons. As a result, the repeated COT-SI may result in more eligible UEs receiving COT-SI, which may lead to more efficient usage of network resources and decreased congestion among sidelink UEs. Moreover, COT-SI may be distributed among UEs in an efficient manner and in a way such that a responding UE may correctly identify an initiator UE of the COT, resulting in reduced communication errors and thus reduced power, computing, and network resource consumption that would otherwise be required for communication errors.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

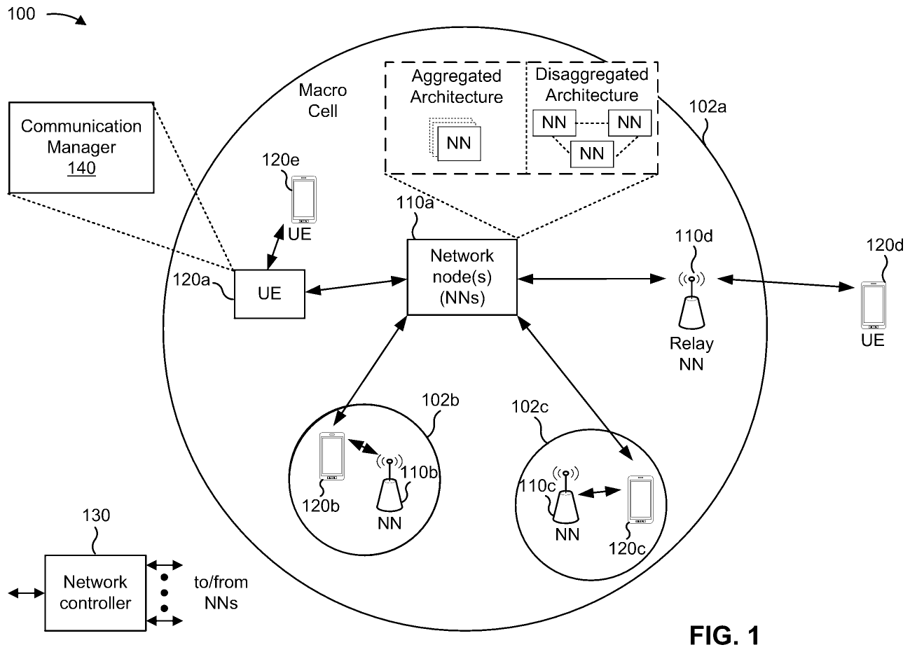

FIG. 1 is a diagram illustrating an example of a wireless network 100, in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel.

Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 megahertz (MHz) −7.125 gigahertz (GHz)) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHz-114.25 GHZ), and FR5 (114.25 GHz-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive, from another UE via a sidelink, COT-SI associated with a first portion of a COT; identify, based at least in part on the COT-SI, that the UE 120 is an eligible repeater UE of the COT-SI; and transmit, based at least in part on the UE 120 being the eligible repeater UE of the COT-SI, a communication using the first portion of the COT, the communication including a repeated COT-SI. In some other aspects, the communication manager 140 may transmit, to another via a sidelink, COT-SI associated with a first portion of a COT; and indicate whether the other UE is an eligible repeater UE of the COT-SI. Additionally, or alternatively, the communication manager 140 may perform one or more other operations described herein.

As indicated above, FIG. 1 is provided as an example. Other examples may differ from what is described with regard to FIG. 1.

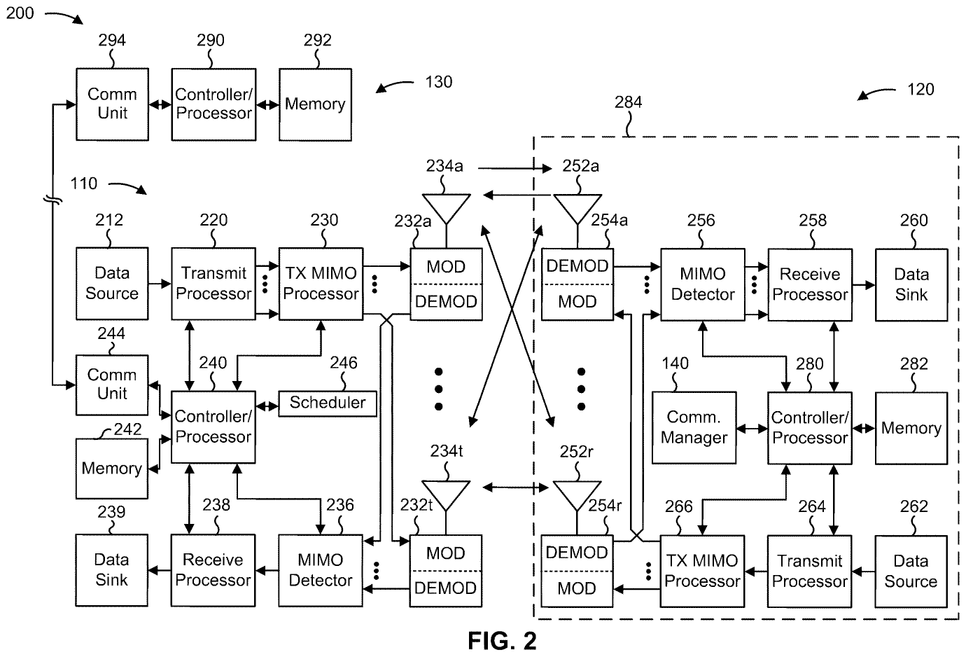

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

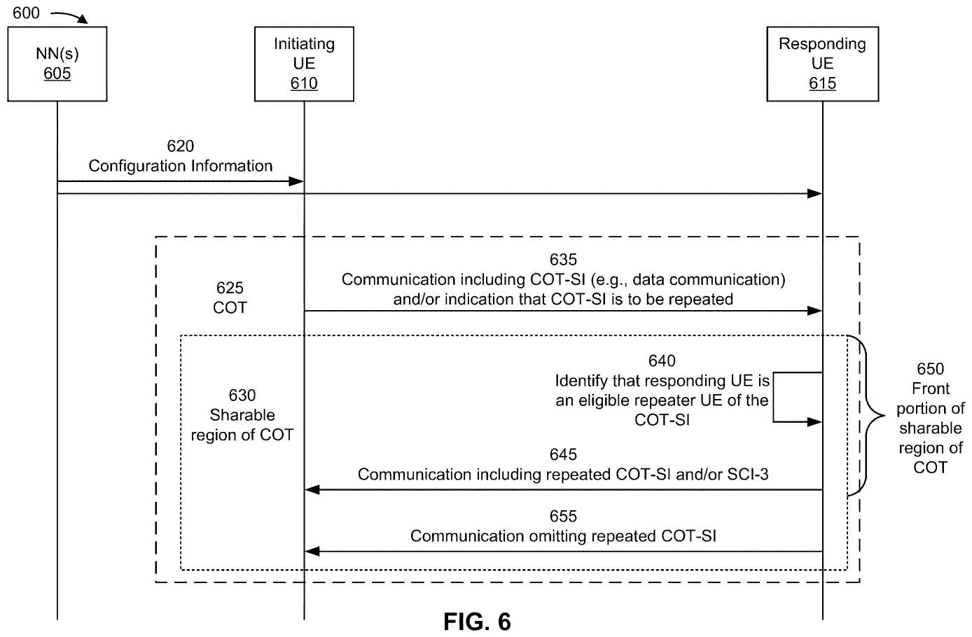

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 6-9).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 6-9).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

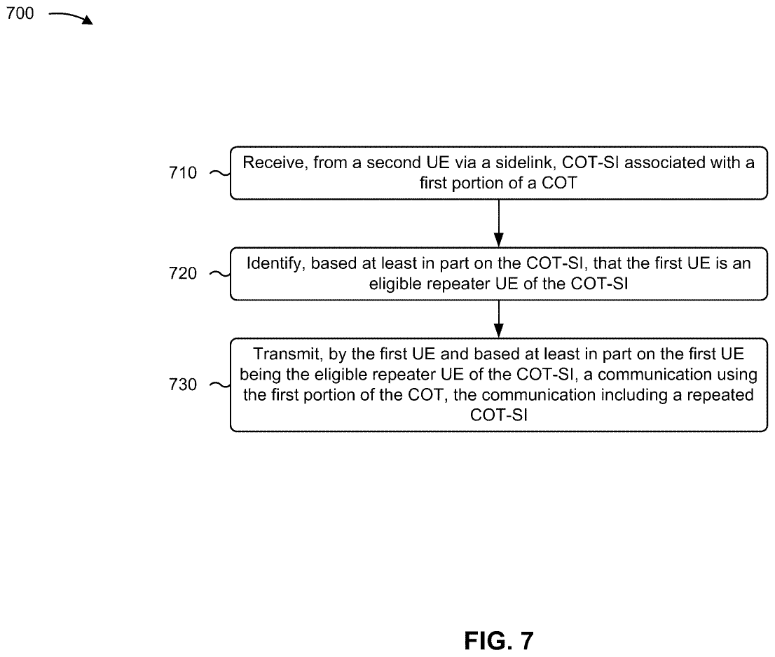

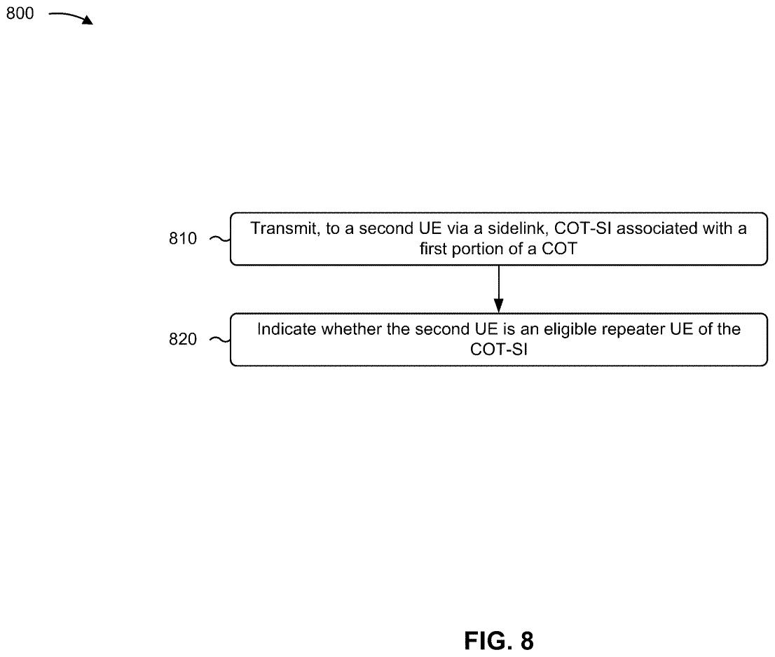

The controller/processor 240 of the network node 110, the controller/processor 280 of the UE 120, or any other component(s) of FIG. 2 may perform one or more techniques associated with repeating COT-SI, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 may correspond to a first UE and/or a second UE described herein. In some aspects, the first UE includes means for receiving, from a second UE via a sidelink, COT-SI associated with a first portion of a COT; means for identifying, based at least in part on the COT-SI, that the first UE is an eligible repeater UE of the COT-SI; and/or means for transmitting, by the first UE and based at least in part on the first UE being the eligible repeater UE of the COT-SI, a communication using the first portion of the COT, the communication including a repeated COT-SI. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the first UE includes means for transmitting, to a second UE via a sidelink, COT-SI associated with a first portion of a COT; and/or means for indicating whether the second UE is an eligible repeater UE of the COT-SI. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

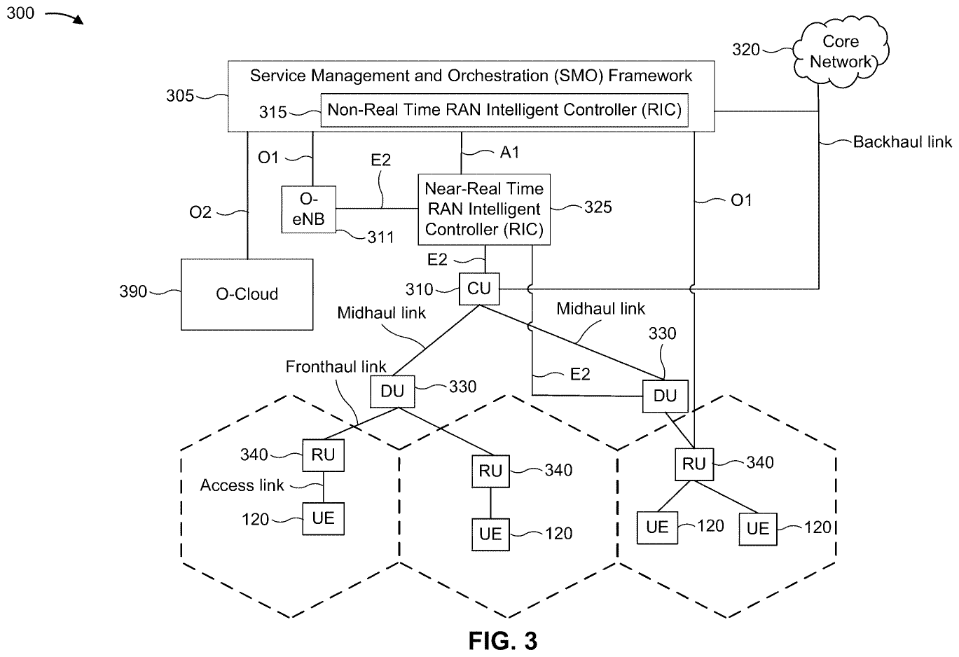

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an Ol interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an Ol interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

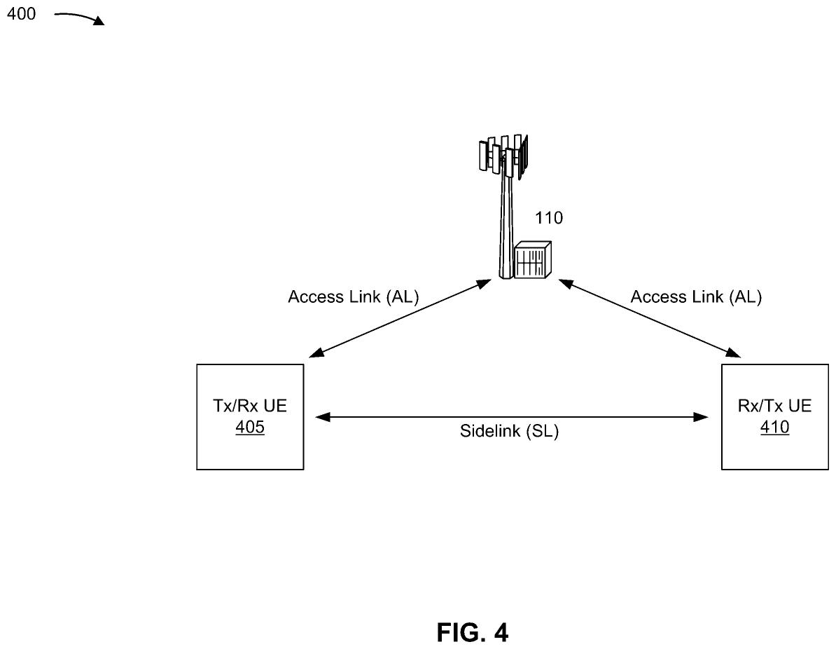

FIG. 4 is a diagram illustrating an example 400 of sidelink communications and access link communications, in accordance with the present disclosure.

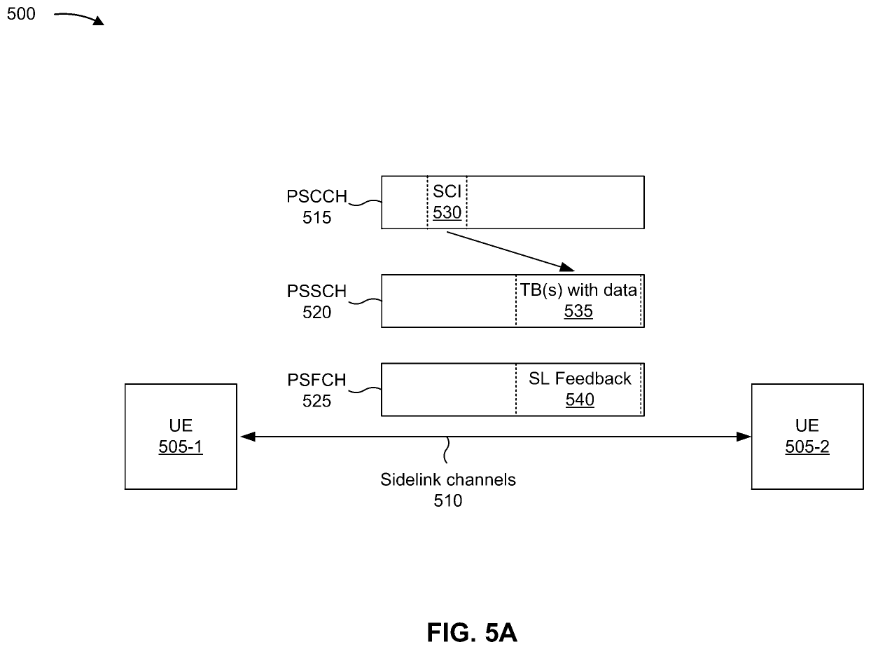

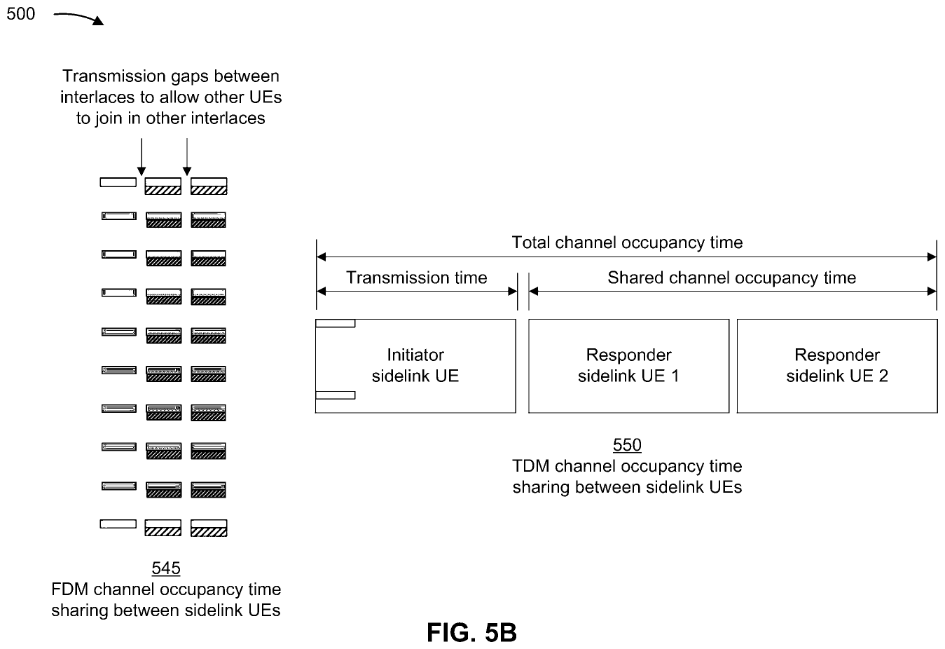

As shown in FIG. 4, a transmitter (Tx)/receiver (Rx) UE 405 and an Rx/Tx UE 410 may communicate with one another via a sidelink. As further shown, in some sidelink modes, a network node 110 may communicate with the Tx/Rx UE 405 (e.g., directly or via one or more network nodes), such as via a first access link. Additionally, or alternatively, in some sidelink modes, the network node 110 may communicate with the Rx/Tx UE 410 (e.g., directly or via one or more network nodes), such as via a first access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110). Aspects of channels that may be communicated via the sidelink are described in more detail below in connection with FIG. 5A.

As indicated above, FIG. 4 is provided as an example. Other examples may differ from what is described with respect to FIG. 4.

FIGS. 5A-5B are diagrams illustrating an example 500 of sidelink communications, in accordance with the present disclosure.

As shown in FIG. 5A, a first UE 505-1 may communicate with a second UE 505-2 (and one or more other UEs 505) via one or more sidelink channels 510. The first UE 505-1 and the second UE 505-2 may correspond to any of the UEs described herein, such as the UE 120 described above in connection with FIGS. 1-3, and/or the Tx/Rx UE 405 or the Rx/Tx UE 410 described above in connection with FIG. 4. The UEs 505-1 and 505-2 may communicate using the one or more sidelink channels 510 for P2P communications, D2D communications, V2X communications (e.g., which may include V2V communications, V2I communications, and/or V2P communications) and/or mesh networking. In some aspects, the one or more sidelink channels 510 may use a PC5 interface and/or may operate in a high frequency band (e.g., the 5.9 GHz band).

Additionally, or alternatively, the UEs 505 may synchronize timing of transmission time intervals (TTIs) (e.g., frames, subframes, slots, or symbols) using global navigation satellite system (GNSS) timing.

As further shown in FIG. 5A, the one or more sidelink channels 510 may include a physical sidelink control channel (PSCCH) 515, a physical sidelink shared channel (PSSCH) 520, and/or a physical sidelink feedback channel (PSFCH) 525. The PSCCH 515 may be used to communicate control information, similar to a physical downlink control channel (PDCCH) and/or a physical uplink control channel (PUCCH) used for cellular communications with a network node 110 via an access link or an access channel. The PSSCH 520 may be used to communicate data, similar to a physical downlink shared channel (PDSCH) and/or a physical uplink shared channel (PUSCH) used for cellular communications with a network node 110 via an access link or an access channel. For example, the PSCCH 515 may carry SCI 530, which may indicate various control information used for sidelink communications, such as one or more resources (e.g., time resources, frequency resources, and/or spatial resources) where a transport block (TB) 535 may be carried on the PSSCH 520. The TB 535 may include data. The PSFCH 525 may be used to communicate sidelink feedback 540, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 515, in some aspects, the SCI 530 may include multiple communications in different stages, such as a first stage SCI (SCI-1) and a second stage SCI (SCI-2). The SCI-1 may be transmitted on the PSCCH 515. The SCI-2 may be transmitted on the PSSCH 520. The SCI-1 may include, for example, an indication of one or more resources (e.g., time resources, frequency resources, and/or spatial resources) on the PSSCH 520, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 520, such as a HARQ process ID, a new data indicator (NDI), a source identifier, a destination identifier, a channel state information (CSI) report trigger, a COT-SI, or similar information.

In some aspects, the one or more sidelink channels 510 may use resource pools. For example, a scheduling assignment (e.g., included in SCI 530) may be transmitted in sub-channels using specific RBs across time. In some aspects, data transmissions (e.g., on the PSSCH 520) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 505 may operate using a sidelink transmission mode (e.g., Mode 1) where resource selection and/or scheduling is performed by a network node 110 (e.g., a base station, a CU, or a DU). For example, the UE 505 may receive a grant (e.g., in downlink control information (DCI) or in an RRC message, such as for configured grants) from the network node 110 (e.g., directly or via one or more network nodes) for sidelink channel access and/or scheduling. In some aspects, a UE 505 may operate using a transmission mode (e.g., Mode 2) where resource selection and/or scheduling is performed by the UE 505 (e.g., rather than a network node 110). In some aspects, the UE 505 may perform resource selection and/or scheduling by sensing channel availability for transmissions. For example, the UE 505 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 505 may perform resource selection and/or scheduling using SCI 530 received in the PSCCH 515, which may indicate occupied resources and/or channel parameters. Additionally, or alternatively, the UE 505 may perform resource selection and/or scheduling by determining a channel busy ratio (CBR) associated with various sidelink channels, which may be used for rate control (e.g., by indicating a maximum number of resource blocks that the UE 505 can use for a particular set of subframes).

In the transmission mode where resource selection and/or scheduling is performed by a UE 505, the UE 505 may generate sidelink grants, and may transmit the grants in SCI 530. A sidelink grant may indicate, for example, one or more parameters (e.g., transmission parameters) to be used for an upcoming sidelink transmission, such as one or more resource blocks to be used for the upcoming sidelink transmission on the PSSCH 520 (e.g., for TBs 535), one or more subframes to be used for the upcoming sidelink transmission, and/or an MCS to be used for the upcoming sidelink transmission. In some aspects, a UE 505 may generate a sidelink grant that indicates one or more parameters for semi-persistent scheduling (SPS), such as a periodicity of a sidelink transmission. Additionally, or alternatively, the UE 505 may generate a sidelink grant for event-driven scheduling, such as for an on-demand sidelink message.

Furthermore, in some aspects, sidelink communications may be transmitted via the sidelink and/or access link communications may be transmitted via the access link in a licensed RF spectrum, an unlicensed RF spectrum, and/or any suitable combination thereof.

For example, to accommodate increasing traffic demands, there have been various efforts to improve spectral efficiency in wireless networks and thereby increase network capacity (e.g., via use of higher order modulations, advanced MIMO antenna technologies, multi-cell coordination techniques, and/or the like). Another way to potentially improve network capacity is to expand system bandwidth. However, available spectrum in lower frequency bands that have traditionally been licensed or otherwise allocated to mobile network operators may be limited.

Accordingly, various technologies have been developed to enable operation of a cellular RAT in unlicensed or other shared spectrum. For example, Licensed-Assisted Access (LAA) uses carrier aggregation on a downlink to combine LTE in a licensed frequency band with LTE in an unlicensed frequency band (e.g., the 2.4 and/or 5 GHZ bands already populated by wireless local area network (WLAN) or “Wi-Fi” devices). In other examples, Enhanced LAA (eLAA) and Further Enhanced LAA (feLAA) technologies enable both uplink and downlink LTE operation in unlicensed spectrum, MulteFire is an LTE-based technology that operates in unlicensed and shared spectrum in a standalone mode, NR unlicensed (NR-U) enables NR operation in unlicensed spectrum, and/or the like. In general, when operating a cellular RAT in unlicensed spectrum (e.g., using LAA, eLAA, feLAA, MulteFire, and/or NR-U), one challenge that arises is the need to ensure fair coexistence with incumbent (e.g., WLAN) systems that may be operating in the unlicensed spectrum.

For example, prior to gaining access to and/or transmitting over an unlicensed channel, a transmitting device (e.g., network node 110, UE 120, Tx/Rx UE 405, Rx/Tx UE 410, UE 505, and/or the like) may need to perform an LBT procedure to contend for access to the unlicensed channel. The LBT procedure may generally include a clear channel assessment (CCA) procedure that is performed in order to determine whether the unlicensed channel is available (e.g., unoccupied by other transmitters). In particular, the CCA procedure may include detecting an energy level on the unlicensed channel and determining whether the energy level satisfies (e.g., is less than or equal to) a threshold, sometimes referred to as an energy detection threshold and/or the like. When the energy level satisfies (e.g., does not equal or exceed) the threshold, the CCA procedure is deemed to be successful and the transmitting device may gain access to the unlicensed channel for a duration that may be referred to as a COT during which the transmitting device can perform transmissions without performing additional LBT operations. When the energy level does not satisfy the threshold, the CCA procedure is unsuccessful and contention to access the unlicensed channel may be deemed unsuccessful.

When the CCA procedure results in a determination that the unlicensed channel band is unavailable (e.g., because the energy level detected on the unlicensed channel indicates that another device is already using the channel), the CCA procedure may be performed again at a later time. In environments in which the transmitting device may obtain limited access to an unlicensed channel (e.g., due to WLAN activity or transmissions by other devices), an extended CCA (eCCA) procedure may be employed to increase the likelihood that the transmitting device will successfully obtain access to the unlicensed channel.

For example, a transmitting device performing an eCCA procedure may perform a random quantity of CCA procedures (from 1 to q), in accordance with an eCCA counter. If and/or when the transmitting device senses that the channel has become clear, the transmitting device may start a random wait period based on the eCCA counter and start to transmit if the channel remains clear over the random wait period.

Accordingly, although a wireless network can be configured to use unlicensed spectrum to achieve faster data rates, provide a more responsive user experience, offload traffic from a licensed spectrum, and/or the like, the need to ensure fair coexistence with incumbent systems (e.g., WLAN devices) may hamper efficient usage of the unlicensed spectrum. For example, even when there is no interference, the LBT procedure used to ensure that no other devices are already using the channel introduces a delay before transmissions can start, which may degrade user experience, result in unacceptable performance for latency-sensitive or delay-sensitive applications, and/or the like. Furthermore, these problems may be exacerbated when the initial CCA procedure is unsuccessful, as the transmitting device can transmit on the channel only after performing an additional quantity of CCA procedures and determining that the channel has become clear and remained clear for a random wait period. Furthermore, in some cases, the channel occupancy time obtained by a transmitting device may have a duration that is longer than necessary for the transmitting device to perform the desired transmissions, which may lead to inefficient usage of the unlicensed channel.

Accordingly, in some cases, a wireless network may enable a COT obtained by a transmitting device to be shared with other nodes in order to improve access, efficiency, and/or the like for an unlicensed channel. For example, in downlink-to-uplink channel occupancy time sharing over an access link, a network node 110 may acquire a COT with an eCCA, and the COT may be shared with one or more UEs (e.g., UE 120, Tx/Rx UE 405, Rx/Tx UE 410, UE 505, and/or the like) that can then transmit uplink signals within the COT acquired by the network node 110. In this case, a UE attempting to initiate an uplink transmission within the COT shared with the network node 110 can perform an uplink transmission without having to perform an LBT procedure, or the UE may perform the uplink transmission after performing a single-shot CCA with a shorter LBT procedure (e.g., a category 2 LBT procedure when the downlink-to-uplink gap duration is between 16 and 25 μs, a category 1 LBT procedure when a downlink-to-uplink gap duration is less than or equal to 16 μs, and/or the like).

Additionally, or alternatively, a wireless network may support uplink-to-downlink channel occupancy time sharing over an access link. In this case, a UE-initiated COT (e.g., for a configured grant PUSCH or a scheduled uplink transmission) can be shared with the network node 110. In this way, the network node 110 may be allowed to transmit control and/or broadcast signals and/or channels for any UE served by the network node 110, provided that the transmission contains a downlink signal, channel, and/or other transmission (e.g., a PDSCH, PDCCH, reference signal, and/or the like) intended to be received by the UE that initiated the channel occupancy.

Additionally, or alternatively, a wireless network may support UE-to-UE COT sharing over a sidelink. For example, as shown in FIG. 5B, and by reference number 545, a COT acquired by an initiator UE (e.g., Tx/Rx UE 405, UE 505-1, which may be a UE that initially performs a Type 1 channel access procedure to acquire a COT) may be shared in a frequency division multiplexing (FDM) mode by dividing the COT into multiple interlaces (e.g., time periods during which one or more UEs may perform transmit operations). For example, as shown in FIG. 5B, the initiator UE may use one or more sidelink resources (e.g., time and frequency resources) to transmit in a first interlace after the COT has been acquired, and a responder UE (e.g., Rx/Tx UE 410, UE 505-2) may use sidelink frequency resources that are non-overlapping with sidelink frequency resources used by the initiator UE to perform transmit operations in subsequent interlaces (e.g., the responder UE may respond using a Type 2 channel access procedure by sharing the COT acquired by the initiator UE). Accordingly, as shown in FIG. 5B, FDM or interlace-based COT sharing may introduce short transmission gaps between interlaces to allow other UEs to perform transmit operations in subsequent interlaces during a shared COT, and sidelink control information transmitted by the initiator UE may carry information to support the interlace-based COT sharing.

Additionally, or alternatively, as shown by reference number 550, UE-to-UE COT sharing may be enabled in a time division multiplexing (TDM) mode. In this case, the total COT may be divided into an initial time period during which the initiator UE may perform transmissions, which may include one or more SCI transmissions that indicate when the initial transmission will end, a remaining duration of the COT that is available for sharing, and/or the like. In some examples, information contained within SCI that is associated with COT sharing may be referred to as COT-SI. Accordingly, one or more responder UEs may monitor the SCI transmitted by other UEs (e.g., the initiator UE) to recover COT-SI that can be used to perform transmissions during a time period that corresponds to a shared COT (e.g., that can be used to enable to the responder UE to use a Type 2 channel access procedure). In some examples, COT-SI may include an indication of a CAPC associated with the shared COT, a remaining COT duration in the shared COT (e.g., a number of sidelink slots remaining in the shared COT, a number of milliseconds (ms) remaining in the shared COT, or a similar indication), an L1 ID associated with the shared COT (e.g., an L1 destination ID, an L1 source ID, and/or a similar L1 ID), an indication of one or more RB sets associated with the shared COT, additional IDs associated with the shared COT (e.g., a COT sharing ID), and/or other information associated with the shared COT (e.g., a communication range, additional information regarding time and/or frequency resources, a starting offset associated with the shared COT and/or a responding UE's transmission, a channel access type associated with the shared COT, or similar information).

In some examples, a UE receiving SCI containing COT-SI (e.g., a responding UE) may identify that it is a target of COT sharing (e.g., a target of the COT-SI) if L1 IDs (e.g., logical source/destination ID pairs for unicast PSCCH/PSSCH transmissions, or logical destination IDs for groupcast or broadcast PSCCH/PSSCH transmissions) contained in the initiator's transmission match logical IDs known at the receiving UE. Additionally, or alternatively, a UE receiving SCI containing COT-SI may identify that it is a target of COT sharing if additional IDs contained in the initiator's transmission (e.g., a COT sharing ID) match logical IDs known at the receiving UE.

Additionally, or alternatively, a UE receiving SCI containing COT-SI may identify that it is a target of COT sharing if a COT sharing ID is received at the responding UE and a COT sharing ID/logical ID mapping has been constructed at the responding UE. In such cases, an initiating UE may provide support for mapping any given COT sharing ID to a set of allowable logical IDs. The COT sharing ID may be recorded by responding UEs that are targets of COT sharing, with the responding UEs associating the COT sharing ID with known logical IDs used by the initiating UE in transmissions that carry such a COT sharing ID (e.g., upon receiving a transmission carrying a COT sharing ID, a responding UE may map the COT sharing ID to one or more logical IDs that are associated with the initiating UE). In such examples, whenever a responding UE receives a transmission including a COT sharing ID, the mapping may indicate a set of logical IDs that may be used for responding.

For example, a first UE, UE1 (which may be an initiating UE), may transmit a unicast communication to a second UE, UE2 (which may be a responding UE), that includes a first source/destination ID pair (e.g., a first source ID and a first destination ID) and a COT sharing ID. UE2 may thus associate the first source ID and/or the first destination ID with the COT sharing ID. Similarly, UE1 may transmit a unicast communication to a third UE, UE3 (which may be another responding UE), that includes a second source/destination ID pair (e.g., a second source ID and a second destination ID) and the COT sharing ID. UE3 may thus associate the second source ID and/or the second destination ID with the COT sharing ID. UE1 may also transmit a groupcast/broadcast communication to a group including UE3 and a fourth UE, UE4 (which may be another responding UE), that includes a third destination ID and the COT sharing ID. UE3 and UE4 may thus associate the third destination ID with the COT sharing ID. Accordingly, in a shared COT, UE2 may respond with a unicast communication using the first source/destination ID pair, because in this example UE2 associated the shared COT (e.g., via the COT sharing ID) with the first source/destination ID pair. Similarly, UE3 may respond with a unicast communication using the second source/destination ID pair or a groupcast/broadcast communication using the third destination ID, because in this example UE3 associated the shared COT with the second source/destination ID pair and the third destination ID. Furthermore, UE4 may respond with a groupcast/broadcast communication using the third destination ID, because in this example UE4 associated the shared COT with the third destination ID.

In some examples, it may be desirable to configure a UE to repeat and/or forward COT-SI in order to ensure that the COT-SI is received by all eligible and/or intended responding UEs. For example, in some examples, COT-SI may be transmitted in a first slot of the COT, and thus certain half-duplex UEs may miss the COT-SI due to the UE otherwise communicating (e.g., transmitting) in the first slot of the COT, which may lead to unutilized resources, increased congestion among sidelink UEs, and/or otherwise inefficient usage of network resources. In such cases, it may be desirable to permit responding UEs to carry COT-SI within their own transmitted SCI, such as for purposes of redundantly sharing COT-SI multiple times during the COT to ensure all eligible UEs receive the COT-SI. However, COT-SI forwarding performed by multiple responding UEs may result in high signaling overhead and/or congested channels. Moreover, a responding UE receiving repeated COT-SI may be unable to identify whether the UE may use the COT to respond to the initiator UE or the repeating UE, resulting in communication errors and thus high power, computing, and network resource consumption associated with correcting communication errors.

Some techniques and apparatuses described herein enable efficient COT-SI forwarding in UE-to-UE COT sharing applications. In some aspects, a responding UE may receive a COT-SI associated with a sharable region of a COT. The responding UE may identify whether it is an eligible repeater UE of the COT-SI, which may be based at least in part on whether the responding UE is a data receiver of the initiating UE, whether the responding UE is a target UE of COT sharing, whether the responding UE is within a given range of the initiating UE, whether the responding UE is capable of decoding the COT-SI, or whether the responding UE meets other criteria. In aspects in which the responding UE is an eligible repeater UE of the COT-SI, the responding UE may repeat and/or forward the COT-SI when transmitting a communication in the sharable region of the COT, thereby repeating the COT-SI for certain UEs that may have otherwise missed the COT-SI from the initiating UE due to half-duplex operation, or the like. As a result, the repeated COT-SI may result in more eligible UEs receiving COT-SI, which may lead to more efficient usage of network resources and decreased congestion among sidelink UEs. Moreover, COT-SI may be distributed among UEs in an efficient manner and in a way such that a responding UEs may correctly identify an initiator UE, resulting in reduced communication errors and thus reduced power, computing, and network resource consumption that would otherwise be required for communication errors.

As indicated above, FIGS. 5A-5B are provided as an example. Other examples may differ from what is described with respect to FIGS. 5A-5B.

FIG. 6 is a diagram of an example 600 associated with repeating COT-SI, in accordance with the present disclosure. As shown in FIG. 6, a network node 605 (e.g., network node 110, a CU, a DU, and/or an RU), an initiating UE 610 (e.g., UE 120, Tx/Rx UE 405, UE 505-1), and a responding UE 615 (e.g., UE 120, Rx/Tx UE 410, UE 505-2) may communicate with each other. In some aspects, the network node 605, the initiating UE 610, and the responding UE 615 may be part of a wireless network (e.g., wireless network 100). The network node 605, the initiating UE 610, and the responding UE 615 may have established a wireless connection prior to operations shown in FIG. 6. For example, the network node 605 may have established an access link connection with the initiating UE 610 and/or the responding UE 615, such as the access link connections described above in connection with FIG. 4, and/or the initiating UE 610 and the responding UE 615 may have established a sidelink connection, such as a connection using the sidelink described above in connection with FIG. 4 and/or a connection using one or more of the sidelink channels 510 described above in connection with FIG. 5A. In some aspects, the initiating UE 610 and the responding UE 615 may be capable of communicating in an unlicensed spectrum (e.g., SL-U), such as by using the Type 1 channel access procedure and/or Type 2 channel access procedure described above in connection with FIGS. 5A-5B.

As shown by reference number 620, the network node 605 may transmit, and the initiating UE 610 and/or the responding UE 615 may receive, configuration information. For example, the initiating UE 610 and/or the responding UE 615 may receive the configuration from the network node 605 via respective access links, such as the access links described above in connection with FIG. 4. In some aspects, the initiating UE 610 and/or the responding UE 615 may receive the configuration information via one or more of RRC signaling, one or more MAC control elements (MAC-CEs), and/or DCI, among other examples. In some aspects, the configuration information may include an indication of one or more configuration parameters (e.g., already known to the initiating UE 610 and/or the responding UE 615 and/or previously indicated by the network node 605 or other network device) for selection by the initiating UE 610 and/or the responding UE 615, and/or explicit configuration information for the initiating UE 610 and/or the responding UE 615 to use to configure the initiating UE 610 and/or the responding UE 615, among other examples.

In some aspects, the configuration information may configure repetition of a COT-SI (sometimes referred to as COT-SI forwarding). For example, the configuration information may configure parameters and/or conditions associated with a responding UE (e.g., responding UE 615) repeating a COT-SI, such as when the responding UE utilizes a sharable region of a COT. In this regard, when so configured, upon receiving an indication of a COT-SI associated with a COT (e.g., COT 625, which is described in more detail below), such as from the initiating UE 610, the responding UE 615 may identify if one or more conditions and/or parameters are satisfied, and, if so, may repeat the COT-SI when responding in a sharable region of the COT (e.g., sharable region 630), which is described in more detail below in connection with reference number 640.

In some aspects, the configuration information may be associated with a resource pool used by the initiating UE 610 and/or the responding UE 615 to transmit communications using the COT. Put another way, in some aspects the enabling of COT-SI forwarding and/or repeating may be RRC configured at the resource pool level. In such aspects, the network node 605, via the configuration information, may enable COT-SI forwarding for a first resource pool, may disable COT-SI sharing for a second resource pool, and so forth. Accordingly, if the responding UE 615 performs a transmission in the first resource pool, the responding UE 615 may repeat the COT-SI, and if the responding UE 615 performs a transmission in the second resource pool, the responding UE 615 may refrain from repeating the COT-SI based at least in part on the configuration information. In some other aspects, the enabling of COT-SI forwarding and/or repeating may be PC5 RRC configured per sidelink. In such aspects, if the responding UE 615 performs a transmission using a sidelink for which COT-SI forwarding is enabled, the responding UE 615 may repeat the COT-SI, and if the responding UE 615 performs a transmission using a sidelink for which COT-SI forwarding is disabled, the responding UE 615 may refrain from repeating the COT-SI.

The initiating UE 610 and/or the responding UE 615 may configure themselves based at least in part on the configuration information. In some aspects, the initiating UE 610 and/or the responding UE 615 may be configured to perform one or more operations described herein based at least in part on the configuration information.

As shown by reference number 635, the initiating UE 610 may transmit (e.g., via a sidelink, such as via a sidelink described above in connection with FIGS. 4-5B), and the responding UE 615 may receive, COT-SI associated with the sharable region 630 of the COT 625. More particularly, the initiating UE 610 may transmit, to the responding UE 615 via a sidelink, a communication (e.g., a communication transmitted via a PSCCH 515, a communication transmitted via a PSSCH 520, or a similar communication) using the COT 625, and the communication may include COT-SI (e.g., within SCI associated with the communication). As described above in connection with FIG. 5B, the COT-SI may include information associated with the COT 625 and/or a sharable region 630 of the COT 625, such as an indication of a CAPC associated with the sharable region 630 of the COT 625, a remaining COT duration (e.g., a number of sidelink slots in the sharable region 630 of the COT 625, a number of ms remaining in the sharable region 630 of the COT 625, or a similar indication), an L1 ID associated with the sharable region 630 of the COT 625 (e.g., an LI destination ID, an L1 source ID, and/or a similar L1 ID), an indication of one or more RB sets associated with the sharable region 630 of the COT 625, additional IDs associated with the sharable region 630 of the COT 625 (e.g., a COT sharing ID), and/or other information associated with the sharable region 630 of the COT 625 (e.g., a communication range, additional information regarding time and/or frequency resources, a starting offset associated with the sharable region 630 of the COT 625 and/or a responding UE's transmission, a channel access type associated with the sharable region 630 of the COT 625, or similar information).

In some aspects, the communication shown in connection with reference number 635 may be a data communication transmitted to the responding UE 615 and/or the COT-SI may be associated with a data communication transmitted to the responding UE 615. In such aspects, the responding UE 615 may be referred to as a data receiver of the initiating UE 610. Additionally, or alternatively, in some aspects, the communication shown in connection with reference number 635 may include and/or be associated with an indication that the COT-SI is to be repeated in the communication transmitted by the responding UE 615 using the sharable region 630 of the COT 625. For example, in some aspects the COT-SI may include a one-bit indicator indicating whether the COT-SI is to be repeated and/or forwarded by the responding UE 615. In such aspects, when the one-bit indicator indicates one of “0” or “1,” the responding UE 615 is to repeat the COT-SI (e.g., COT-SI forwarding is enabled), and when the one-bit indicator indicates the other one of “0” or “1,” the responding UE 615 is not to repeat the COT-SI (e.g., COT-SI forwarding is disabled), which is described in more detail below in connection with reference number 640.

In some aspects, the initiating UE 610 and/or the responding UE 615 may receive, from the network node 605, configuration information configuring repetition of the COT-SI (as described above in connection with reference number 620), and, once configured, the initiating UE 610 may indicate whether the responding UE 615 is to repeat the COT-SI via the indication associated with the COT-SI (e.g., the one-bit indication). Put another way, if the network node 605 enables COT-SI forwarding in a certain resource pool or otherwise, the COT-SI transmitted via the communication shown in connection with reference number 635 may include one additional bit to indicate enabling of COT-SI forwarding, such that whether the responding UE 615 should forward COT-SI is indicated by the initiating UE 610 in the COT-SI.

In some aspects, the initiating UE 610 may make a determination whether the responding UE 615 is to repeat the COT-SI based at least in part on a priority level of responding UEs transmissions. For example, the initiating UE 610 may receive an indication of respective priority levels associated with responding UEs' reserved resources. If the average priority level and/or highest priority level satisfies a priority level threshold, the initiating UE 610 may enable COT-SI. If the average priority level and/or highest priority level does not satisfy a priority level threshold, the initiating UE 610 may disable COT-SI. For example, the initiating UE 610 may be configured with, specified with, hard-coded with, or otherwise be associated with a priority level threshold, such as a priority level threshold equal to “2.” Moreover, a transmission of a first responding UE that has reserved resources associated with the sharable region 630 of the COT 625 may be associated with a priority level of “1” (e.g., a highest priority level), a transmission of a second responding UE that has reserved resources associated with the sharable region 630 of the COT 625 may be associated with a priority level of “3,” and a transmission of a third responding UE that has reserved resources associated with the sharable region 630 of the COT 625 may be associated with a priority level of “2.” In some aspects, the initiating UE 610 may enable COT-SI forwarding (e.g., may set the one-bit indicator), because the average priority level (2) satisfies the priority level threshold (2). In some other aspects, the initiating UE 610 may enable COT-SI forwarding (e.g., may set the one-bit indicator), because the highest priority level (1) satisfies the priority level threshold (2).

As shown by reference number 640, the responding UE 615 may identify that the responding UE 615 is an eligible repeater UE of the COT-SI based at least in part on the COT-SI. In some aspects, the responding UE 615 may identify that the responding UE 615 is an eligible repeater UE of the COT-SI based at least in part on whether the responding UE 615 is a data receiver of the initiating UE 610 (e.g., in some aspects, an eligible repeater UE is a data receiver of the COT initiator). In that regard, the responding UE 615 may identify that the responding UE 615 is an eligible repeater UE of the COT-SI when IDs (e.g., a source/destination ID pair for a unicast transmission, a destination ID for a groupcast or broadcast transmission) contained in the communication including the COT-SI (e.g., the communication described above in connection with reference number 635) match logical IDs known to the responding UE 615. In such aspects, the responding UE 615 may receive, from the initiating UE 610 via the sidelink, a data communication associated with the COT-SI, and the responding UE 615 may identify that the responding UE 615 is an eligible repeater UE of the COT-SI based at least in part on the responding UE 615 receiving the data communication (e.g., based at least in part of the responding UE 615 being a data receiver of the initiating UE 610).

Additionally, or alternatively, the responding UE 615 may identify that the responding UE 615 is an eligible repeater UE of the COT-SI based at least in part on the responding UE 615 identifying that the responding UE 615 is a target UE of the COT-SI. In some aspects, the responding UE 615 may identify that responding UE 615 is a target UE of the COT-SI based at least in part on at least one ID contained within the COT-SI. For example, the at least one ID may be at least one L1 ID contained within a source ID field and/or a destination ID field of the COT-SI (e.g., a source/destination ID pair for a unicast transmission, or a destination ID for a groupcast or broadcast transmission). In some other aspects, the at least one ID may be an ID indicated by an additional ID field of the COT-SI, such as a COT sharing ID contained within an additional ID field. In such aspects, if the responding UE 615 identifies that the one or more IDs of the COT-SI match logical IDs known at the responding UE 615 (e.g., stored in a layer 2 mapping, or the like), the responding UE 615 may identify that the responding UE 615 is a target of the COT-SI and thus an eligible repeater UE of the COT-SI.

Additionally, or alternatively, the responding UE 615 may identify that the responding UE 615 is an eligible repeater UE of the COT-SI based at least in part on the responding UE 615 identifying that the responding UE 615 is within a certain range of the initiating UE 610. In some aspects, the responding UE 615 may identify that the responding UE 615 is within the certain range (and thus an eligible repeater UE) based at least in part on an RSRP associated with a communication between the responding UE 615 and the initiating UE 610 (e.g., the communication described above in connection with reference number 635) satisfying an RSRP threshold. More particularly, the responding UE 615 may measure the RSRP of the communication carrying the COT-SI, and, if the RSRP satisfies an RSRP threshold, the responding UE 615 may determine that is near to the initiating UE 610 (e.g., within the certain range of the initiating UE 610) and thus is an eligible repeater UE.

Additionally, or alternatively, the responding UE 615 may identify that it is within the certain range (and thus an eligible repeater UE) based at least in part on the responding UE 615 being associated with a same zone identifier as a zone identifier of the initiating UE 610. More particularly, in some aspects the responding UE 615 may be configured to determine a zone ID (sometimes referred to as Zone_id) associated with a zone in which it is located using a formula. More particularly, the responding UE 615 may be configured to determine a zone ID via a sidelink zone configuration information element (IE), sometimes referred to as sl-ZoneConfig, which may be part of the configuration information described above in connection with reference number 620. In some aspects, the responding UE 615 may determine a zone ID based at least in part on the formula Zone_id=y1×64+x1, where x1=Floor (x/L) Mod 64, y1=Floor (y/L) Mod 64, L is a value of a zone length parameter (sometimes referred to as sl-ZoneLength) indicated by a sidelink zone configuration IE (e.g., sl-ZoneConfig), x is the geodesic distance in longitude between the responding UE 615's current location and geographical coordinates (0, 0) according to a World Geodetic System 1984 (WGS84) model (expressed in meters), and y is the geodesic distance in latitude between the responding UE 615's current location and geographical coordinates (0, 0) according to the WGS84 model (expressed in meters). In that regard, a zone ID may be used as a identification to represent a UE's location, with a granularity of the zone ID being dependent on the configured L value. In such aspects, if the initiating UE 610 and the responding UE 615 share the same zone ID (e.g., determined according to the above-described formula), the responding UE 615 may identify that it is an eligible repeater UE of the COT-SI.

Additionally, or alternatively, the responding UE 615 may identify that the responding UE 615 is an eligible repeater UE of the COT-SI based at least in part on the responding UE 615 decoding the COT-SI. Put another way, in some aspects, any responding UE that is capable of decoding the COT-SI may be an eligible repeater UE, and thus may repeat the COT-SI when responding in the sharable region 630 of the COT 625.

As shown by reference number 645, the responding UE 615 may transmit, and the initiating UE 610 and/or another UE may receive, a communication using a first portion of the COT 625 (e.g., the sharable region 630 of the COT 625). For example, using the parameters indicated by the COT-SI, the responding UE 615 may utilize the COT 625 (more particularly, the sharable region 630 of the COT 625) to transmit a communication in the sidelink. Moreover, in aspects in which the responding UE 615 identified that the responding UE 615 is an eligible repeater UE of the COT-SI (as described above in connection with reference number 640), the responding UE 615 may repeat the COT-SI in the communication (e.g., in SCI associated with the communication). Put another way, in some aspects the communication shown in connection with reference number 645 may include a repeated COT-SI based at least in part on the responding UE 615 identifying that the responding UE 615 is an eligible repeater UE of the COT-SI.

In some aspects, the responding UE 615 may indicate that the repeated COT-SI is coming from the responding UE 615 and not the COT initiator (e.g., the initiating UE 610). This may be because, upon receiving a COT-SI, a responding UE (e.g., the responding UE 615 an/or one or more other responding UEs) may map logical identifiers associated with the COT-SI (e.g., a COT sharing ID contained in an additional ID field of the COT-SI or the like) to logical IDs associated with the transmitting UE. Accordingly, in examples in which the responding UE 615 repeats the COT-SI (e.g., includes the repeated COT-SI in the communication indicated by reference number 645) without an indication that the responding UE 615 is repeating the COT-SI, another responding UE may erroneously associate the COT-SI with the responding UE 615 (e.g., may map a COT sharing ID to a logical ID associated with the responding UE 615). Accordingly, in some aspects, the COT-SI and/or the repeated COT-SI may include an indicator indicating whether the COT-SI is being transmitting by the COT initiator (e.g., initiating UE 610) or a responding UE (e.g., responding UE 615). For example, the COT-SI may include a one-bit indication that is set to one of “0” or “1” when the COT-SI originates from the COT initiator (e.g., the initiating UE 610) and that is set to the other one of “0” or “1” when the COT-SI originates from a responding UE (e.g., the responding UE 615). Accordingly, in such aspects, the COT-SI transmitted by the initiating UE 610 (e.g., the COT-SI included with the communication described above in connection with reference number 635) may include an indication that the COT-SI is transmitted by the initiating UE 610, and/or the repeated COT-SI transmitted by the responding UE 615 (e.g., the COT-SI included with the communication described above in connection with reference number 645) may include an indication that the repeated COT-SI is not transmitted by the initiating UE 610. In such cases, a UE receiving the repeated COT-SI may identify that certain IDs associated with the repeated COT-SI that correspond the responding UE 615 (e.g., a source/destination ID pair for a unicast transmission, a destination ID for a groupcast and/or broadcast transmission, or the like) may not be used to determine if the UE is a target of the COT-SI.

Additionally, or alternatively, the responding UE 615 may update certain information associated with the COT-SI when repeating and/or forwarding the COT-SI, such as information associated with a remaining COT duration, information regarding time and/or frequency resources, or similar information. In this regard, in some aspects, the COT-SI transmitted by the initiating UE 610 (e.g., the COT-SI included with the communication described above in connection with reference number 635) may include an indication of time resources and/or frequency resources associated with the sharable region 630 of the COT 625, and the repeated COT-SI transmitted by the responding UE 615 (e.g., the COT-SI included with the communication described above in connection with reference number 645) may include an indication of time resources and/or frequency resources associated with a portion of the sharable region 630 of the COT 625 that remains after the communication including the repeated COT-SI (e.g., the communication described above in connection with reference number 645) is transmitted.

Additionally, or alternatively, the COT-SI may include an indication of an offset between an initial COT-SI reception time (e.g., a reception time associated with the COT-SI being transmitted by the COT initiator, such as the initiating UE 610) and a COT-SI forwarding time (e.g., a time at which the COT-SI is forwarded and/or repeated by an eligible repeater UE, such as responding UE 615). In such aspects, if the offset is equal to zero, a responding UE receiving the COT-SI may identify that COT-SI is a COT-SI being transmitted by a COT initiator (e.g., initiating UE 610), and if the offset is greater than zero, a responding UE receiving the COT-SI may identify that COT-SI is a repeated COT-SI being transmitted by another responding UE (e.g., responding UE 615). Accordingly, in some aspects, the COT-SI transmitted by the initiating UE 610 (e.g., the COT-SI included with the communication described above in connection with reference number 635) may include an indication of a zero offset between an initial COT-SI reception time and a COT-SI forwarding time, and the repeated COT-SI transmitted by the responding UE 615 (e.g., the COT-SI included with the communication described above in connection with reference number 645) may include an indication of a greater than zero offset between the initial COT-SI reception time and the COT-SI forwarding time.

Additionally, or alternatively, in some aspects, when repeating the COT-SI, the responding UE 615 may indicate additional information associated with the COT initiator (e.g., the initiating UE 610) such that other responding UEs receiving the repeated COT-SI may map the COT initiator to the COT-SI. For example, in some aspects, the responding UE 615 may transmit, with the communication using the sharable region 630 of the COT 625 (e.g., the communication described above in connection with reference number 645), a third stage SCI (SCI-3) indicating one or more logical IDs associated with the initiating UE 610. In such aspects, if the COT-SI comes from the initiating UE 610 (e.g., as described above in connection with reference number 635), the SCI-3 may not be transmitted. Accordingly, a UE receiving the COT-SI (e.g., the responding UE 615 and/or one or more other responding UEs) may map a COT sharing ID associated with the COT 625 to logical IDs (e.g., source ID and/or destination ID contained in SCI-2) from the COT initiator (e.g., the initiating UE 610). On the other hand, if the COT-SI comes from the responding UE 615 or another eligible repeater UE (e.g., as described above in connection with reference number 645), the SCI-3 may be transmitted. Accordingly, a UE receiving the repeated COT-SI (e.g., one or more other responding UEs) may map a COT sharing ID associated with the COT 625 to logical IDs (e.g., source ID and/or destination ID) contained in SCI-3.

In some aspects, an eligible repeater UE (e.g., the responding UE 615) may only repeat the COT-SI if certain other conditions are met. Put another way, in some aspects, not all eligible repeater UEs will repeat the COT-SI when responding in the COT. For example, in some aspects, when an eligible repeater UE (e.g., the responding UE 615) receives a COT-SI from another UE, the eligible repeater UE may only forward and/or repeat the COT-SI when a portion of the sharable region of the COT to be used by the eligible repeater UE is located at a front portion of the sharable region of the COT. In some aspects, the front portion of the sharable region of the COT may be defined according to a first-occurring percentage parameter (sometimes referred to as X). For example, in some aspects, an eligible repeater UE may only repeat a COT-SI if the eligible repeater UE is transmitting a communication in the first X % of slots in the sharable region of the COT.

In the example shown in FIG. 6, the front portion of the sharable region of the COT is indicated by reference number 650. As shown, the communication including the repeated COT-SI (e.g., the communication described above in connection with reference number 645) occurs within the front portion of the sharable region of the COT. Accordingly, in some aspects, the responding UE 615 may include the repeated COT-SI in the communication using the sharable region of the COT based at least in part on the communication being transmitted in the front portion of the sharable region of the COT. Moreover, in some aspects, the front portion of the sharable region of the COT may associated with a first-occurring percentage (e.g., X %) of the sharable region of the COT, as described above. Additionally, or alternatively, the responding UE 615 may receive, from the network node 605 via an access link, configuration information indicating the first-occurring percentage of the sharable region of the COT (e.g., the responding UE 615 may receive an indication of the first-occurring percentage value via the configuration information described above in connection with reference number 620). In that regard, and as indicated by reference number 655, in some aspects the responding UE 615 may transmit a communication in the sharable region 630 of the COT 625 that occurs after the front portion (e.g., after the first X % of slots). In some aspects, the responding UE 615 may omit the COT-SI from the communication (e.g., may not repeat the COT-SI) notwithstanding that the responding UE 615 is an eligible repeater UE, because the communication is occurring after the front portion of the sharable region 630 of the COT 625.

In some aspects, upon receiving a COT-SI from another UE (e.g., the initiating UE 610), an eligible repeater UE (e.g., the responding UE 615) may forward and/or repeat the COT-SI one time within the sharable region 630 of the COT 625 and/or within a configured portion of the sharable region 630 of the COT 625. In this regard, the responding UE 615 may repeat the COT-SI for any other responding UEs that may have missed the initial transmission of the COT-SI from the initiating UE 610, but the responding UE 615 may refrain from repeating the COT-SI multiple times in order to reduce overhead associated with repetition of the COT-SI. For example, as shown in FIG. 6, in some aspects the responding UE 615 may transmit a first communication in the sharable region 630 of the COT 625 that includes the repeated COT-SI (e.g., the communication shown in connection with reference number 645), and the responding UE 615 may transmit a second communication in the sharable region 630 of the COT 625 that omits the repeated COT-SI (e.g., the communication shown in connection with reference number 655). Put another way, in some aspects, the responding UE 615 may include the repeated COT-SI in the communication using the sharable region 630 of the COT 625 (e.g., the communication shown in connection with reference number 645) based at least in part on the communication being a first-occurring transmission, of multiple transmissions, performed by the responding UE 615 during the sharable region 630 of the COT 625.

Based at least in part on the responding UE 615 identifying whether the responding UE 615 is an eligible repeater UEs of a COT-SI and repeating a COT-SI accordingly, the responding UE 615, the initiating UE 610, the network node 605, and/or other responding UEs may conserve computing, power, network, and/or communication resources that may have otherwise been consumed communication schemes in which a COT-SI is transmitted only a single time by the initiating UE 610. For example, based at least in part on the responding UE 615 identifying whether the responding UE 615 is an eligible repeater UEs of a COT-SI and repeating a COT-SI accordingly, more responding UEs may receive the COT-SI and thus utilize the sharable region 630 of the COT 625, thereby improving resource utilization and resulting in more efficient usage of network resources.

As indicated above, FIG. 6 is provided as an example. Other examples may differ from what is described with respect to FIG. 6.

FIG. 7 is a diagram illustrating an example process 700 performed, for example, by a first UE, in accordance with the present disclosure. Example process 700 is an example where the first UE (e.g., responding UE 615) performs operations associated with techniques for repeating COT-SI.

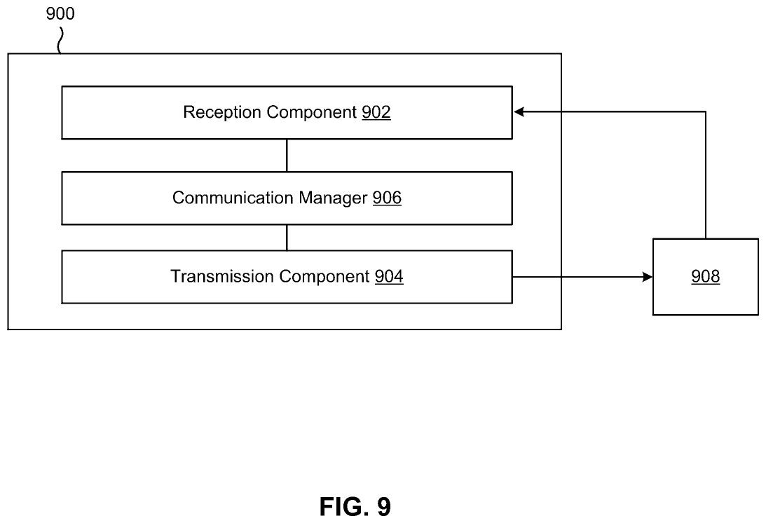

As shown in FIG. 7, in some aspects, process 700 may include receiving, from a second UE (e.g., initiating UE 610) via a sidelink, COT-SI associated with a first portion of a COT (block 710). For example, the first UE (e.g., using reception component 902 and/or communication manager 906, depicted in FIG. 9) may receive, from a second UE via a sidelink, COT-SI associated with a first portion of a COT, as described above.

As further shown in FIG. 7, in some aspects, process 700 may include identifying, based at least in part on the COT-SI, that the first UE is an eligible repeater UE of the COT-SI (block 720). For example, the first UE (e.g., using communication manager 906, depicted in FIG. 9) may identify, based at least in part on the COT-SI, that the first UE is an eligible repeater UE of the COT-SI, as described above.

As further shown in FIG. 7, in some aspects, process 700 may include transmitting, based at least in part on the first UE being the eligible repeater UE of the COT-SI, a communication using the first portion of the COT, the communication including a repeated COT-SI (block 730). For example, the first UE (e.g., using transmission component 904 and/or communication manager 906, depicted in FIG. 9) may transmit, based at least in part on the first UE being the eligible repeater UE of the COT-SI, a communication using the first portion of the COT, the communication including a repeated COT-SI, as described above.

Process 700 may include additional aspects, such as any single aspect or any combination of aspects described below and/or in connection with one or more other processes described elsewhere herein.

In a first aspect, process 700 includes receiving, from the second UE via the sidelink, a data communication associated with the COT-SI, wherein the identification that the first UE is an eligible repeater UE of the COT-SI is based at least in part on the first UE receiving the data communication.

In a second aspect, alone or in combination with the first aspect, the identification that the first UE is an eligible repeater UE of the COT-SI is based at least in part on the first UE identifying that at least one logical identifier associated with the COT-SI corresponds to the first UE.

In a third aspect, alone or in combination with one or more of the first and second aspects, the identification that the first UE is an eligible repeater UE of the COT-SI is based at least in part on the first UE identifying that the first UE is a target UE of the COT-SI.

In a fourth aspect, alone or in combination with one or more of the first through third aspects, the identification that the first UE is an eligible repeater UE of the COT-SI is based at least in part on an RSRP associated with a communication between the first UE and the second UE satisfying an RSRP threshold.

In a fifth aspect, alone or in combination with one or more of the first through fourth aspects, the identification that the first UE is an eligible repeater UE of the COT-SI is based at least in part on the first UE being associated with a same zone identifier as a zone identifier of the second UE.

In a sixth aspect, alone or in combination with one or more of the first through fifth aspects, the identification that the first UE is an eligible repeater UE of the COT-SI is based at least in part on the first UE decoding the COT-SI.

In a seventh aspect, alone or in combination with one or more of the first through sixth aspects, process 700 includes receiving configuration information configuring repetition of the COT-SI.

In an eighth aspect, alone or in combination with one or more of the first through seventh aspects, the configuration information is received from a network node via an access link.

In a ninth aspect, alone or in combination with one or more of the first through eighth aspects, the configuration information is associated with a resource pool used by the first UE to transmit the communication using the first portion of the COT.

In a tenth aspect, alone or in combination with one or more of the first through ninth aspects, the configuration information is received from the second UE via the sidelink.

In an eleventh aspect, alone or in combination with one or more of the first through tenth aspects, process 700 includes receiving, from the second UE via the sidelink, an indication that the COT-SI is to be repeated in the communication transmitted by the first UE using the first portion of the COT.

In a twelfth aspect, alone or in combination with one or more of the first through eleventh aspects, the indication that the COT-SI is to be repeated is a one-bit indicator associated with the COT-SI.

In a thirteenth aspect, alone or in combination with one or more of the first through twelfth aspects, the indication that the COT-SI is to be repeated is based at least in part on at least one of an average priority level of one or more responding UEs associated with the first portion of the COT satisfying a priority level threshold, or a highest priority level of the one or more responding UEs associated with the first portion of the COT satisfying the priority level threshold.

In a fourteenth aspect, alone or in combination with one or more of the first through thirteenth aspects, process 700 includes receiving, from a network node via an access link, configuration information configuring repetition of the COT-SI, and receiving, from the second UE via the sidelink, an indication that the COT-SI is to be repeated in the communication transmitted by the first UE using the first portion of the COT.

In a fifteenth aspect, alone or in combination with one or more of the first through fourteenth aspects, including the repeated COT-SI in the communication using the first portion of the COT is based at least in part on the communication being transmitted in a front portion of the first portion of the COT.

In a sixteenth aspect, alone or in combination with one or more of the first through fifteenth aspects, the front portion of the first portion of the COT is associated with a first-occurring percentage of the first portion of the COT.

In a seventeenth aspect, alone or in combination with one or more of the first through sixteenth aspects, process 700 includes receiving, from a network node via an access link, configuration information indicating the first-occurring percentage of the first portion of the COT.

In an eighteenth aspect, alone or in combination with one or more of the first through seventeenth aspects, including the repeated COT-SI in the communication using the first portion of the COT is based at least in part on the communication being a first-occurring transmission, of multiple transmissions, performed by the first UE during the first portion of the COT.

In a nineteenth aspect, alone or in combination with one or more of the first through eighteenth aspects, the COT-SI includes an indication that the COT-SI is transmitted by the second UE, and the repeated COT-SI includes an indication that the repeated COT-SI is not transmitted by the second UE.

In a twentieth aspect, alone or in combination with one or more of the first through nineteenth aspects, the COT-SI includes an indication of at least one of time resources or frequency resources associated with the first portion of the COT, and the repeated COT-SI includes an indication of at least one of time resources or frequency resources associated with a second portion of the first portion of the COT that remains after the communication including the repeated COT-SI is transmitted.

In a twenty-first aspect, alone or in combination with one or more of the first through twentieth aspects, the COT-SI includes an indication of a zero offset between an initial COT-SI reception time and a COT-SI forwarding time, and the repeated COT-SI includes an indication of a greater than zero offset between the initial COT-SI reception time and the COT-SI forwarding time.

In a twenty-second aspect, alone or in combination with one or more of the first through twenty-first aspects, process 700 includes transmitting, with the communication using the first portion of the COT, a third stage sidelink control information indicating one or more logical identifiers associated with the second UE.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a first UE, in accordance with the present disclosure. Example process 800 is an example where the first UE (e.g., initiating UE 610) performs operations associated with techniques for repeating COT-SI.

As shown in FIG. 8, in some aspects, process 800 may include transmitting, to a second UE via a sidelink, COT-SI associated with a first portion of a COT (block 810). For example, the first UE (e.g., using transmission component 904 and/or communication manager 906, depicted in FIG. 9) may transmit, to a second UE via a sidelink, COT-SI associated with a first portion of a COT, as described above.

As further shown in FIG. 8, in some aspects, process 800 may include indicating whether the second UE is an eligible repeater UE of the COT-SI (block 820). For example, the first UE (e.g., using communication manager 906, depicted in FIG. 9) may indicate whether the second UE is an eligible repeater UE of the COT-SI, as described above.

Process 800 may include additional aspects, such as any single aspect or any combination of aspects described below and/or in connection with one or more other processes described elsewhere herein.

In a first aspect, process 800 includes transmitting, to the second UE via the sidelink, a data communication associated with the COT-SI, wherein the indication whether the second UE is an eligible repeater UE of the COT-SI is based at least in part on transmitting the data communication to the second UE.

In a second aspect, alone or in combination with the first aspect, the indication whether the second UE is an eligible repeater UE of the COT-SI is based at least in part on including, in the COT-SI, at least one logical identifier corresponding to the second UE.

In a third aspect, alone or in combination with one or more of the first and second aspects, the indication whether the second UE is an eligible repeater UE of the COT-SI is based at least in part on the second UE being a target UE of the COT-SI.

In a fourth aspect, alone or in combination with one or more of the first through third aspects, the indication whether the second UE is an eligible repeater UE of the COT-SI is based at least in part on an RSRP associated with a communication between the second UE and the first UE satisfying an RSRP threshold.

In a fifth aspect, alone or in combination with one or more of the first through fourth aspects, the indication whether the second UE is an eligible repeater UE of the COT-SI is based at least in part on the second UE being associated with a same zone identifier as a zone identifier of the first UE.

In a sixth aspect, alone or in combination with one or more of the first through fifth aspects, the indication whether the second UE is an eligible repeater UE of the COT-SI is based at least in part on the second UE being capable of decoding the COT-SI.

In a seventh aspect, alone or in combination with one or more of the first through sixth aspects, process 800 includes receiving, from a network node via an access link, configuration information configuring repetition of the COT-SI.

In an eighth aspect, alone or in combination with one or more of the first through seventh aspects, the configuration information is associated with a resource pool used by the first UE to transmit the COT-SI.

In a ninth aspect, alone or in combination with one or more of the first through eighth aspects, process 800 includes transmitting, to the second UE via the sidelink, an indication that the COT-SI is to be repeated in a communication transmitted by the second UE using the first portion of the COT.

In a tenth aspect, alone or in combination with one or more of the first through ninth aspects, the indication that the COT-SI is to be repeated is a one-bit indicator associated with the COT-SI.

In an eleventh aspect, alone or in combination with one or more of the first through tenth aspects, the indication that the COT-SI is to be repeated is based at least in part on at least one of an average priority level of one or more responding UEs associated with the first portion of the COT satisfying a priority level threshold, or a highest priority level of the one or more responding UEs associated with the first portion of the COT satisfying the priority level threshold.

In a twelfth aspect, alone or in combination with one or more of the first through eleventh aspects, process 800 includes receiving, from a network node via an access link, configuration information configuring repetition of the COT-SI, and transmitting, to the second UE via the sidelink, an indication that the COT-SI is to be repeated in a communication transmitted by the second UE using the first portion of the COT.

In a thirteenth aspect, alone or in combination with one or more of the first through twelfth aspects, the COT-SI includes an indication that the COT-SI is transmitted by the first UE.

In a fourteenth aspect, alone or in combination with one or more of the first through thirteenth aspects, the COT-SI includes an indication of a zero offset between an initial COT-SI reception time and a COT-SI forwarding time.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a first UE (e.g., initiating UE 610, responding UE 615), or a first UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a second UE (e.g., initiating UE 610, responding UE 615) or a network node (such as a CU, a DU, an RU, or a base station), using the reception component 902 and the transmission component 904.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7, process 800 of FIG. 8, or a combination thereof. In some aspects, the apparatus 900 and/or one or more components shown in FIG. 9 may include one or more components of the UE 120 described in connection with FIG. 2.

Additionally, or alternatively, one or more components shown in FIG. 9 may be implemented within one or more components described in connection with FIG. 2.

Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE 120 described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE 120 described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a second UE via a sidelink, COT-SI associated with a first portion of a COT. The communication manager 906 may identify, based at least in part on the COT-SI, that the first UE is an eligible repeater UE of the COT-SI. The transmission component 904 may transmit, based at least in part on the first UE being the eligible repeater UE of the COT-SI, a communication using the first portion of the COT, the communication including a repeated COT-SI.

The reception component 902 may receive, from the second UE via the sidelink, a data communication associated with the COT-SI, wherein the identification that the first UE is an eligible repeater UE of the COT-SI is based at least in part on the first UE receiving the data communication. The reception component 902 may receive configuration information configuring repetition of the COT-SI. The reception component 902 may receive, from the second UE via the sidelink, an indication that the COT-SI is to be repeated in the communication transmitted by the first UE using the first portion of the COT. The reception component 902 may receive, from a network node via an access link, configuration information configuring repetition of the COT-SI. The reception component 902 may receive, from a network node via an access link, configuration information indicating the first-occurring percentage of the first portion of the COT.

The transmission component 904 may transmit, with the communication using the first portion of the COT, a third stage sidelink control information indicating one or more logical identifiers associated with the second UE. The transmission component 904 may transmit, to a second UE via a sidelink, COT-SI associated with a first portion of a COT. The communication manager 906 may indicate whether the second UE is an eligible repeater UE of the COT-SI. The transmission component 904 may transmit, to the second UE via the sidelink, a data communication associated with the COT-SI, wherein the indication whether the second UE is an eligible repeater UE of the COT-SI is based at least in part on transmitting the data communication to the second UE.

The reception component 902 may receive, from a network node via an access link, configuration information configuring repetition of the COT-SI. The transmission component 904 may transmit, to the second UE via the sidelink, an indication that the COT-SI is to be repeated in a communication transmitted by the second UE using the first portion of the COT.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a first UE, comprising: receiving, from a second UE via a sidelink, COT-SI associated with a first portion of a COT; identifying, based at least in part on the COT-SI, that the first UE is an eligible repeater UE of the COT-SI; and transmitting, by the first UE and based at least in part on the first UE being the eligible repeater UE of the COT-SI, a communication using the first portion of the COT, the communication including a repeated COT-SI.

Aspect 2: The method of Aspect 1, further comprising receiving, from the second UE via the sidelink, a data communication associated with the COT-SI, wherein the identification that the first UE is an eligible repeater UE of the COT-SI is based at least in part on the first UE receiving the data communication.

Aspect 3: The method of any of Aspects 1-2, wherein the identification that the first UE is an eligible repeater UE of the COT-SI is based at least in part on the first UE identifying that at least one logical identifier associated with the COT-SI corresponds to the first UE.

Aspect 4: The method of any of Aspects 1-3, wherein the identification that the first UE is an eligible repeater UE of the COT-SI is based at least in part on the first UE identifying that the first UE is a target UE of the COT-SI.

Aspect 5: The method of any of Aspects 1-4, wherein the identification that the first UE is an eligible repeater UE of the COT-SI is based at least in part on an RSRP associated with a communication between the first UE and the second UE satisfying an RSRP threshold.

Aspect 6: The method of any of Aspects 1-5, wherein the identification that the first UE is an eligible repeater UE of the COT-SI is based at least in part on the first UE being associated with a same zone identifier as a zone identifier of the second UE.

Aspect 7: The method of any of Aspects 1-6, wherein the identification that the first UE is an eligible repeater UE of the COT-SI is based at least in part on the first UE decoding the COT-SI.

Aspect 8: The method of any of Aspects 1-7, further comprising receiving configuration information configuring repetition of the COT-SI.

Aspect 9: The method of Aspect 8, wherein the configuration information is received from a network node via an access link.

Aspect 10: The method of Aspect 9, wherein the configuration information is associated with a resource pool used by the first UE to transmit the communication using the first portion of the COT.

Aspect 11: The method of Aspect 8, wherein the configuration information is received from the second UE via the sidelink.

Aspect 12: The method of any of Aspects 1-11, further comprising receiving, from the second UE via the sidelink, an indication that the COT-SI is to be repeated in the communication transmitted by the first UE using the first portion of the COT.

Aspect 13: The method of Aspect 12, wherein the indication that the COT-SI is to be repeated is a one-bit indicator associated with the COT-SI.

Aspect 14: The method of Aspect 12, wherein the indication that the COT-SI is to be repeated is based at least in part on at least one of: an average priority level of one or more responding UEs associated with the first portion of the COT satisfying a priority level threshold, or a highest priority level of the one or more responding UEs associated with the first portion of the COT satisfying the priority level threshold.

Aspect 15: The method of any of Aspects 1-14, further comprising: receiving, from a network node via an access link, configuration information configuring repetition of the COT-SI; and receiving, from the second UE via the sidelink, an indication that the COT-SI is to be repeated in the communication transmitted by the first UE using the first portion of the COT.

Aspect 16: The method of any of Aspects 1-15, wherein including the repeated COT-SI in the communication using the first portion of the COT is based at least in part on the communication being transmitted in a front portion of the first portion of the COT.

Aspect 17: The method of Aspect 16, wherein the front portion of the first portion of the COT is associated with a first-occurring percentage of the first portion of the COT.

Aspect 18: The method of Aspect 17, further comprising receiving, from a network node via an access link, configuration information indicating the first-occurring percentage of the first portion of the COT.

Aspect 19: The method of any of Aspects 1-18, wherein including the repeated COT-SI in the communication using the first portion of the COT is based at least in part on the communication being a first-occurring transmission, of multiple transmissions, performed by the first UE during the first portion of the COT.

Aspect 20: The method of any of Aspects 1-19, wherein the COT-SI includes an indication that the COT-SI is transmitted by the second UE, and wherein the repeated COT-SI includes an indication that the repeated COT-SI is not transmitted by the second UE.

Aspect 21: The method of any of Aspects 1-20, wherein the COT-SI includes an indication of at least one of time resources or frequency resources associated with the first portion of the COT, and wherein the repeated COT-SI includes an indication of at least one of time resources or frequency resources associated with a second portion of the first portion of the COT that remains after the communication including the repeated COT-SI is transmitted.

Aspect 22: The method of any of Aspects 1-21, wherein the COT-SI includes an indication of a zero offset between an initial COT-SI reception time and a COT-SI forwarding time, and wherein the repeated COT-SI includes an indication of a greater than zero offset between the initial COT-SI reception time and the COT-SI forwarding time.

Aspect 23: The method of any of Aspects 1-22, further comprising transmitting, with the communication using the first portion of the COT, a third stage sidelink control information indicating one or more logical identifiers associated with the second UE.

Aspect 24: A method of wireless communication performed by a first UE, comprising: transmitting, to a second UE via a sidelink, COT-SI associated with a first portion of a COT; and indicating whether the second UE is an eligible repeater UE of the COT-SI.

Aspect 25: The method of Aspect 24, further comprising transmitting, to the second UE via the sidelink, a data communication associated with the COT-SI, wherein the indication whether the second UE is an eligible repeater UE of the COT-SI is based at least in part on transmitting the data communication to the second UE.

Aspect 26: The method of any of Aspects 24-25, wherein the indication whether the second UE is an eligible repeater UE of the COT-SI is based at least in part on including, in the COT-SI, at least one logical identifier corresponding to the second UE.

Aspect 27: The method of any of Aspects 24-26, wherein the indication whether the second UE is an eligible repeater UE of the COT-SI is based at least in part on the second UE being a target UE of the COT-SI.

Aspect 28: The method of any of Aspects 24-27, wherein the indication whether the second UE is an eligible repeater UE of the COT-SI is based at least in part on an RSRP associated with a communication between the second UE and the first UE satisfying an RSRP threshold.

Aspect 29: The method of any of Aspects 24-28, wherein the indication whether the second UE is an eligible repeater UE of the COT-SI is based at least in part on the second UE being associated with a same zone identifier as a zone identifier of the first UE.

Aspect 30: The method of any of Aspects 24-29, wherein the indication whether the second UE is an eligible repeater UE of the COT-SI is based at least in part on the second UE being capable of decoding the COT-SI.

Aspect 31: The method of any of Aspects 24-30, further comprising receiving, from a network node via an access link, configuration information configuring repetition of the COT-SI.

Aspect 32: The method of Aspect 31, wherein the configuration information is associated with a resource pool used by the first UE to transmit the COT-SI.

Aspect 33: The method of any of Aspects 24-32, further comprising transmitting, to the second UE via the sidelink, an indication that the COT-SI is to be repeated in a communication transmitted by the second UE using the first portion of the COT.

Aspect 34: The method of Aspect 33, wherein the indication that the COT-SI is to be repeated is a one-bit indicator associated with the COT-SI.

Aspect 35: The method of Aspect 33, wherein the indication that the COT-SI is to be repeated is based at least in part on at least one of: an average priority level of one or more responding UEs associated with the first portion of the COT satisfying a priority level threshold, or a highest priority level of the one or more responding UEs associated with the first portion of the COT satisfying the priority level threshold.

Aspect 36: The method of any of Aspects 24-35, further comprising: receiving, from a network node via an access link, configuration information configuring repetition of the COT-SI; and transmitting, to the second UE via the sidelink, an indication that the COT-SI is to be repeated in a communication transmitted by the second UE using the first portion of the COT.

Aspect 37: The method of any of Aspects 24-36, wherein the COT-SI includes an indication that the COT-SI is transmitted by the first UE.

Aspect 38: The method of any of Aspects 24-37, wherein the COT-SI includes an indication of a zero offset between an initial COT-SI reception time and a COT-SI forwarding time.

Aspect 39: An apparatus for wireless communication at a device, comprising a processor; memory coupled with the processor; and instructions stored in the memory and executable by the processor to cause the apparatus to perform the method of one or more of Aspects 1-38.

Aspect 40: A device for wireless communication, comprising a memory and one or more processors coupled to the memory, the one or more processors configured to perform the method of one or more of Aspects 1-38.

Aspect 41: An apparatus for wireless communication, comprising at least one means for performing the method of one or more of Aspects 1-38.

Aspect 42: A non-transitory computer-readable medium storing code for wireless communication, the code comprising instructions executable by a processor to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous.

Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

1. A first user equipment (UE) for wireless communication, comprising:
a memory; and
one or more processors, coupled to the memory, configured to:
receive, from a second UE via a sidelink, channel occupancy time (COT) sharing information (COT-SI) associated with a first portion of a COT;
identify, based at least in part on the COT-SI, that the first UE is an eligible repeater UE of the COT-SI; and
transmit, based at least in part on the first UE being the eligible repeater UE of the COT-SI, a communication using the first portion of the COT, the communication including a repeated COT-SI.

2. The first UE of claim 1, wherein the one or more processors are further configured to receive, from the second UE via the sidelink, a data communication associated with the COT-SI, wherein the one or more processors, to identify that the first UE is an eligible repeater UE of the COT-SI, are further configured to identify that the first UE is an eligible repeater UE of the COT-SI based at least in part on the first UE receiving the data communication.

3. The first UE of claim 1, wherein the one or more processors, to identify that the first UE is an eligible repeater UE of the COT-SI, are further configured to identify that the first UE is an eligible repeater UE of the COT-SI based at least in part on the first UE identifying that at least one logical identifier associated with the COT-SI corresponds to the first UE.

4. The first UE of claim 1, wherein the one or more processors, to identify that the first UE is an eligible repeater UE of the COT-SI, are further configured to identify that the first UE is an eligible repeater UE of the COT-SI based at least in part on the first UE identifying that the first UE is a target UE of the COT-SI.

5. The first UE of claim 1, wherein the one or more processors, to identify that the first UE is an eligible repeater UE of the COT-SI, are further configured to identify that the first UE is an eligible repeater UE of the COT-SI based at least in part on a reference signal received power (RSRP) associated with a communication between the first UE and the second UE satisfying an RSRP threshold.

6. The first UE of claim 1, wherein the one or more processors, to identify that the first UE is an eligible repeater UE of the COT-SI, are further configured to identify that the first UE is an eligible repeater UE of the COT-SI based at least in part on the first UE being associated with a same zone identifier as a zone identifier of the second UE.

7. The first UE of claim 1, wherein the one or more processors, to identify that the first UE is an eligible repeater UE of the COT-SI, are further configured to identify that the first UE is an eligible repeater UE of the COT-SI based at least in part on the first UE decoding the COT-SI.

8. The first UE of claim 1, wherein the one or more processors are further configured to receive configuration information configuring repetition of the COT-SI.

9. The first UE of claim 8, wherein the one or more processors are further configured to receive the configuration information from a network node via an access link.

10. The first UE of claim 9, wherein the configuration information is associated with a resource pool used by the first UE to transmit the communication using the first portion of the COT.

11. The first UE of claim 8, wherein the one or more processors are further configured to receive the configuration information from the second UE via the sidelink.

12. The first UE of claim 1, wherein the one or more processors are further configured to receive, from the second UE via the sidelink, an indication that the COT-SI is to be repeated in the communication transmitted by the first UE using the first portion of the COT.

13. The first UE of claim 12, wherein the indication that the COT-SI is to be repeated is a one-bit indicator associated with the COT-SI.

14. The first UE of claim 12, wherein the indication that the COT-SI is to be repeated is based at least in part on at least one of:
an average priority level of one or more responding UEs associated with the first portion of the COT satisfying a priority level threshold, or
a highest priority level of the one or more responding UEs associated with the first portion of the COT satisfying the priority level threshold.

15. The first UE of claim 1, wherein the one or more processors are further configured to:
receive, from a network node via an access link, configuration information configuring repetition of the COT-SI; and
receive, from the second UE via the sidelink, an indication that the COT-SI is to be repeated in the communication transmitted by the first UE using the first portion of the COT.

16. The first UE of claim 1, wherein the one or more processors, to include the repeated COT-SI in the communication using the first portion of the COT, are further configured to include the repeated COT-SI in the communication using the first portion of the COT based at least in part on the communication being transmitted in a front portion of the first portion of the COT.

17. The first UE of claim 16, wherein the front portion of the first portion of the COT is associated with a first-occurring percentage of the first portion of the COT.

18. The first UE of claim 17, wherein the one or more processors are further configured to receive, from a network node via an access link, configuration information indicating the first-occurring percentage of the first portion of the COT.

19-26. (canceled)

27. A method of wireless communication performed by a first user equipment (UE), comprising:
receiving, from a second UE via a sidelink, channel occupancy time (COT) sharing information (COT-SI) associated with a first portion of a COT;
identifying, based at least in part on the COT-SI, that the first UE is an eligible repeater UE of the COT-SI; and
transmitting, by the first UE and based at least in part on the first UE being the eligible repeater UE of the COT-SI, a communication using the first portion of the COT, the communication including a repeated COT-SI.

28. The method of claim 27, further comprising transmitting, with the communication using the first portion of the COT, a third stage sidelink control information indicating one or more logical identifiers associated with the second UE.

29-30. (canceled)
